(19) United States
(12) Patent Application Publication
(10) Pub. No.: US 2014/0302873 A1
(43) Pub. Date: Oct. 9, 2014

(54) LOCATION VERIFICATION IN COMMUNICATION SYSTEMS

(71) Applicants: Ruediger Halfmann, Otterberg (DE); Christian Markwart, Munich (DE); Wolfgang Zirwas, Munich (DE)

(72) Inventors: Ruediger Halfmann, Otterberg (DE); Christian Markwart, Munich (DE); Wolfgang Zirwas, Munich (DE)

(73) Assignee: NOKIA SOLUTIONS AND NETWORKS OY, Espoo (FI)

(21) Appl. No.: 14/354,168

(22) PCT Filed: Oct. 28, 2011
(86) PCT No.: PCT/EP2011/069010

§ 371 Date: Apr. 25, 2014

(51) Int. Cl. H04W 64/00; H04W 48/16; H04W 60/00

(52) U.S. Cl. CPC H04W 64/003; H04W 60/00; H04W 48/16
USPC 455/456.1

(57) ABSTRACT

A method of verifying the location of a home base station (102) comprises the steps of receiving at the home base station (102) a broadcast Femto location identifier (FID) transmitted by nearby macro base stations (108, 110) and checking at the home base station (102) or at any network entity (SON or OAM server) whether the Femto location identifier (FID) is valid for the location of the home base station (102) in order to verify its location. The method may be applied during discovery and registration of home base station (102) and also subsequently.

This invention relates to location verification (LV) in communication systems. It is particularly, but not exclusively, related to verifying the location of a base station in a cellular communications system.

Studies show that up to 70 percent of mobile phone calls take place while a user of a mobile phone is located indoors. However, Radio Access Networks (RANs) currently in operation have been developed for outdoor use. As a result, the mobile service available in homes and office buildings is often weak or non-existent. Until indoor coverage is as good as, or better than, outdoor coverage, Mobile Network Operators (MNOs) will not be able to wean users off fixed-line phones entirely or to realise the full revenue potential of wireless high-speed data and video services.

One way of providing improved indoor mobile service is by use of very small base stations indoors, that is home base stations. In a 3GPP (Third Generation Partnership Project) context, home base stations are referred to as Femto base stations. Femto base stations based on third generation (3G) radio access technology (RAT) are called home NodeBs (HNBs). Femto base stations based on Long Term Evolution (LTE) RAT are called home enhanced NodeBs (HeNBs). A general term, home (enhanced) NodeBs (H(e)NBs), is used to refer to Femto base stations of either RAT type. A Femto base station may also be referred to as a Femto access point, or FAP.

In a cellular system, macrocells are provided by NodeB (NB) base stations in a 3G system, and by enhanced NodeB (eNB) base stations in an LTE system. The term (e)NB is used to apply, in general, to the base stations of either system. The base stations may have coverage limitations, specifically due to strong outdoor-to-indoor penetration loss. This can easily be up to 20 dB.

In addition to circumventing penetration loss, home base stations located in homes and buildings provide data offloading in cellular mobile radio systems such as 3GPP LTE systems. Use of home base stations is beneficial to MNOs because base station sites are provided free of charge by end users and installation involves a low cost/effort. End users may be rewarded by a single numbering scheme and a single integrated communication platform for all their communication needs.

Base stations, such as NBs, eNBs and Femtos, have to be connected to a core network and for Femto base stations it has been proposed to use widely deployed digital subscriber lines (DSL) to provide the connection. While most communications service providers (CSPs) provide DSL lines at a flat rate and permit the DSL access to be used for any data communication, there may be some regulatory, contractual or technical restrictions, for example related to usage profiles for residential or business installations. It is desirable to avoid users other than those allowed, for example nominated, by the owner of the home environment, that is the subscriber/owner of the DSL line and the home base station, being permitted to establish a call via the assigned home base station. For that reason access to each home base station may be restricted to so-called closed subscriber groups (CSGs).

Home base stations operate in defined and licensed parts of the electromagnetic spectrum. In order to operate, they need a connection to a network operator's core network in order to receive, and in some cases exchange, Operation, Administration, and Maintenance (OAM) traffic, management plane (m-plane) traffic, user plane (u-plane) traffic, and control plane (c-plane) traffic. In this context, it is important to secure this environment so as to reduce the risks of misuse, unwanted manipulation of credentials and/or of equipment/systems, and hacking attacks against the core network. Therefore, the following security principles are defined for home base stations:

a) they must run in a secure boot environment; and

b) m-plane, u-plane, and c-plane traffic all have to be integrity protected.

Principle a) is met locally at a home base station and principle b) is met by using an IPSec (Internet Protocol (IP) security tunnel) where the home base station is one end point and a network element in the core network, referred to as the Security Gateway (SeGW), is the other end point.

Since home base stations are operated in a part or parts of the electromagnetic spectrum licensed to a network operator, there is usually an associated geographical restriction applied to the use of the home base station, for example to a particular country.

Another aspect of control needing to be exercised by an MNO is the need to avoid interference with macro base stations in areas where macro base stations and home base stations are operating in parallel. Therefore, the operation of a home base station, for example its operating frequencies and power, is specified as being compatible with its local environment in order to avoid interference with nearby macro base stations.

OAM messages are exchanged between an OAM system and a home base station for other purposes including activation of the home base station and definition of the CSG. In order for a home base station to be activated so that it operates correctly, its location has to be taken into account. Therefore, LV operation may be performed in respect of the home base station. This can avoid conflicts between a newly set up home base station and outdoor macro deployments, for example to avoid prohibited power settings which might significantly disturb other users of a macro base station such as an eNB.

The following three methods have been defined for location verification in respect of 3GPP Femto base stations:

1) checking broadband credentials (for example checking of a public IP address);

2) a radio neighbourhood check; and/or

3) a Global Positioning System (GPS) location data check.

As mentioned in the foregoing, a Femto base station is typically installed inside a building which means that it might not be straightforward for any one, or for any combination, of the above LV checking methods to provide a valid LV result. Unfortunately, in real world scenarios, the defined LV methods may have problems for a number of reasons. Indoor reception of GPS signals may be problematic. Neighbourhood detection, that is determining cell identifiers of other base stations in the vicinity of the Femto base station under investigation, may not deliver valid results when it is installed in a basement. A public IP address may not be useable if the Femto base station is connected to a residential gateway (DSL router) because the Femto base station may provide to an OAM system or to a network element in the core network a private IP address (for example 192.168.1.x) which is also used by hundreds of other home networks.

A proposal has been made for Femto base stations to carry out LV by detecting macro cell identities (cell IDs) from nearby macro cells which are transmitted in packet data broadcast channel (PDBCH) messages. However, as can be seen in the foregoing, Femto base stations may be placed at low coverage areas, or even in coverage holes, of a network. For that reason, conventional PDBCH messages might be in many cases not detectable/decodeable by Femto base stations and thus not useable for LV.

In addition, there is the possibility of fraud if a broadcast channel (BCH) message containing a cell ID is replaced with a fake cell ID. If there is no protection mechanism, a potential hacker can send fake cell IDs to a Femto base station to mis-represent to a network operator that the Femto base station is at an expected location. Although this possibility is low, because it would require considerable effort, a secure means of carrying out LV is desirable.

It may be impractical to extend the mobile network functionality with a secure protection and supervisory capability to monitor the location of a home base station because the overhead would be too high due to the expected high number of home base stations expected to be deployed in the future.

In summary, checking broadband credentials presents problems in being used in home environments, checking GPS information is often impractical indoors, and checking the radio neighbourhood is also uncertain in cases where a Femto base station is used to fill a coverage hole.

According to a first aspect of the invention there is provided a method of verifying the location of a home base station comprising the steps of:

receiving a broadcast location identifier; and

checking whether the location identifier is valid for the location of the home base station in order to verify its location.

The location identifier may be broadcast by a macro base station. It may be broadcast by one or more home base stations.

The location identifier may be a Femto identifier. It may be unique to a particular base station and identify that base station. It may be unique to a cluster of base stations with reuse applied to one or more base stations further away. It may be unique to a network. It may be unique to a region. It may be unique to a country.

The home base station may be connected to a network in respect of which is operates as an access point. It may provide access as part of a radio access network. It may have a broadband connection to a core network.

Location verification may be performed during a discovery and registration procedure of a home base station. It may occur during a registration procedure with an OAM system. It may occur during a registration procedure with a network. It may occur during operation of a home base station.

The method may verify location to a coarse degree. For example, it may determine whether the home base station is in a particular network, region, or country. In this case, all macro base stations in the location may broadcast a similar or even an identical location identifier. The method may verify location to a fine degree. For example, it may determine whether the home base station is in a specific location localised to a particular macro base station, such as within a location of hundreds of metres. In one embodiment of the invention, verification may be performed as a coarse location check and as a fine location check. This may occur either at the same times or at different times, for example during different operations.

The method may be carried out each time a home base station is switched on.

The location identifier may be locked to a network element. It may be locked to the home base station or to an entity of a core network or an OAM system. The location identifier may be overwritten. If a received location identifier has already been locked, this may indicate that the location of a home base station has not been changed. If it is determined that a new location identifier belongs to an expected location, the home base station or another network element may be instructed to lock the new location identifier which is then stored.

In the event that a home base station is re-located, the home base station or another network element may check if any reported new location identifiers match a registered new location and, if a move has been registered with a relevant re-location functionality, operation of the home base station in its new location may be permitted. In this case, one or more old location identifiers may be deleted and replaced with one or more new location identifiers. These may be locked at the home base station.

The method may be performed in a network. This may be in an OAM system and/or in a SON server. It may be performed in another network entity, for example a gateway or a mobility management entity. It may be performed directly in a home base station. It may be performed indirectly in a home base station operating together with a network based entity.

A location verification server function may be implemented in the home base station, a gateway, an OAM system, or in any other appropriate network node.

The method may be based on an expected location identifier. This may be configured to the home base station or to another network element or entity. A counterpart to an expected location identifier may be so configured.

The location identifier may be used as an encryption and/or decryption key by the home base station and a network element configured to communicate with the home base station. One may be configured with the location identifier and the other may be configured with a counterpart to the location identifier. The home base station or the network element may encrypt a message or a part thereof. It may encrypt a code based on the contents of a packet. If the code cannot be decrypted correctly by a receiving entity, this may indicate that a location identifier used in encryption is not an expected location identifier.

A mobile terminal may be capable of detecting the location identifier and providing it to the home base station. In this way, the mobile terminal may act like a relay. The mobile terminal or the home base station may receive the location identifier and confirm, or reject, its validity.

The location identifiers, or messages containing them, may be encoded and/or modulated in a form having a strong coding gain. Strong coding may be provided by simple repetition coding of the location identifiers/messages. Any repetition factor may be reduced by more efficient coding schemes and/or by providing macro diversity.

The may be several adjacent macro base stations configured to transmit the same location identifier simultaneously to allow a gain provided by macro base station diversity. If this provides a sufficient reception gain for receipt of the location identifier at home base stations, applying a coding gain may not be necessary, or the amount of coding gain required may be reduced when compared to relying solely on coding gain without there being any macro base station diversity gain.

There may be a lifetime, or a period of validity, associated with the location identifier. It may be changed from time to time. A different location identifier may be used for each transmission. Randomly generated location identifiers may be used.

The home base station may be informed about a measurement time window where the next location identifier will be broadcast.

Preferably, the method is applied in a mobile network.

According to a second aspect of the invention there is provided a network node capable of verifying the location of a home base station, the network node comprising a receiving block capable of receiving a broadcast location identifier; and

a checking block to determine whether the location identifier is valid for the location of the home base station in order to verify its location.

The network node may be the home base station.

The network node may comprise a memory store capable of storing one or more expected location identifiers. It may comprise a memory store capable of storing policies applicable to determining validity of the location identifier.

According to a third aspect of the invention there is provided a network comprising:

a plurality of base stations capable of broadcasting a location identifier; and

a network node capable of verifying the location of a home base station, the network node comprising a receiving block capable of receiving a broadcast location identifier and a checking block to determine whether the location identifier is valid for the location of the home base station in order to verify its location.

According to a fourth aspect of the invention there is provided a computer program product comprising software code that when executed on a computing system performs a method of verifying the location of a home base station comprising the steps of:

receiving a broadcast location identifier; and

checking whether the location identifier is valid for the location of the home base station in order to verify its location.

Preferably, the computer program product has executable code portions which are capable of carrying out the steps of the method.

Preferably, the computer program product is stored on a computer-readable medium.

Embodiments of the invention will now be described, by way of example only, with reference to the accompanying drawings in which:

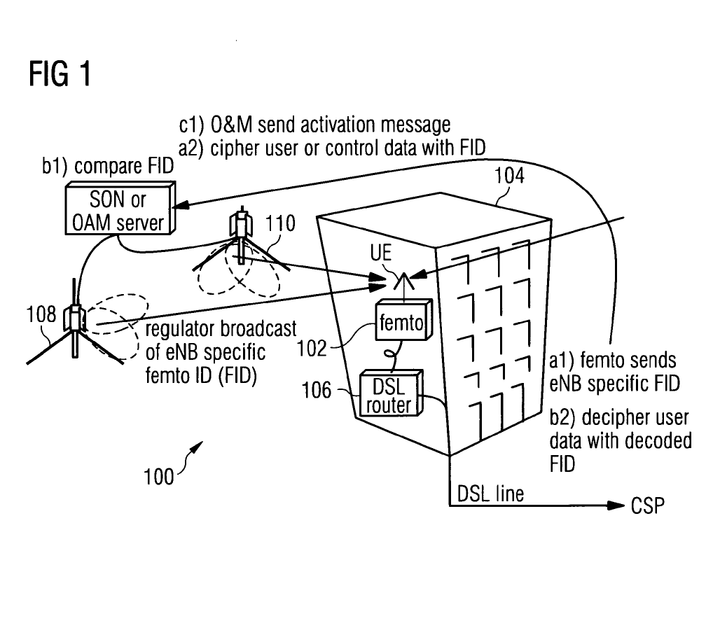

FIG. 1 shows a system in which location verification is carried out;

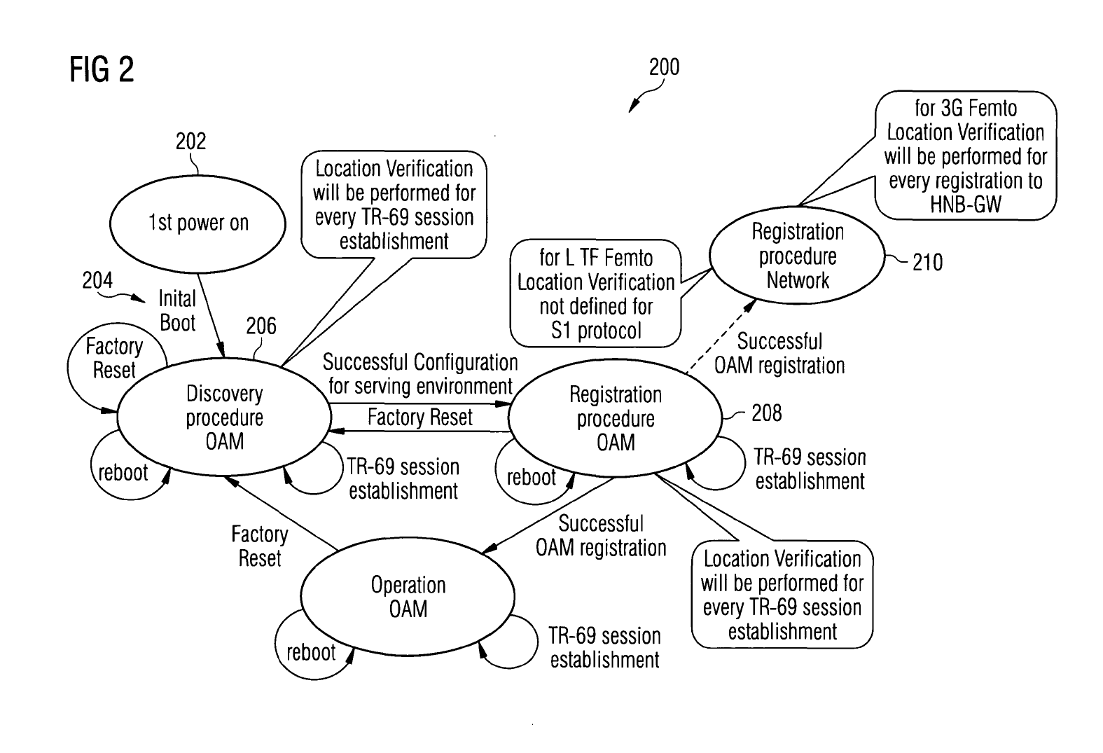

FIG. 2 shows a state model for registration of Femto base stations; and

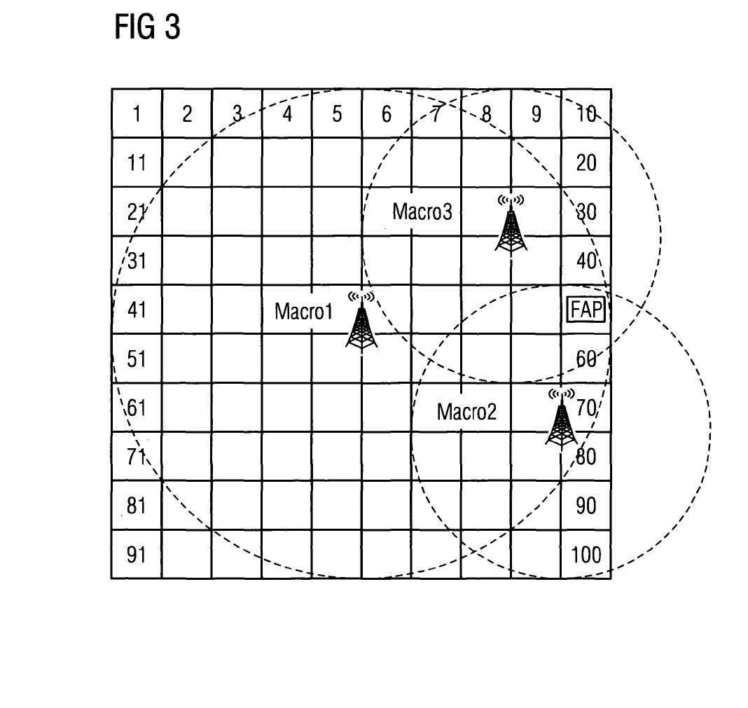

FIG. 3 shows an arrangement of a Femto base station and macro base stations.

FIG. 1 shows a system 100 in which location verification (LV) is carried out. The system 100 comprises a Femto base station 102 located in a building 104, a DSL router 106 connecting the Femto base station 102 to a CSP, and a number of macro base stations 108, 110, in the neighbourhood of the Femto base station 102. These are connected to a core network of the system 100. The CSP is connected to an MNO domain which incorporates an OAM system. FIG. 1 also shows method steps according to the invention.

Initially, a Femto base station might be switched on but not registered for operation in a network. At this time, the Femto base station will be able to receive signalling and messages but not to transmit. Therefore, the Femto base station is able to receive information to be used for LV even though it has not been put into full operation.

The macro base stations, for example eNBs, broadcast Femto discovery messages referred to as Femto Identifiers (FIDs). The purpose of the FIDs is to be received by the Femto base station 102 in order that a determination may be made as to the location of the Femto base station 102. As such, they can be considered to be Femto location identifiers. Location verification may be used to guarantee that home base stations transmit (send) in the licensed spectrum only when the location is correct. There are two aspects of location which may be confirmed: whether a home base station is in the correct region in terms of licensed spectrum; and whether it is in the correct location for compatibility with the network environment. As will be explained in the following, the location determinable from an FID may be a very coarse location, such as a country or region in a country, or a fine location, such as an area localised to part of a town or city or even a number of streets. In the former case, all macro base stations in the country or the region may broadcast a similar or even an identical FID. In the latter case, an FID may indicate a macro base station, or several macro base stations, by which it was broadcast, and assuming the location(s) of the macro base station or base stations is/are known, it is possible to determine the location of the Femto base station receiving the FID.

LV will now be put into context. LV is performed during a discovery and registration procedure of a Femto base station. FIG. 2 shows a state model 200 for registration of Femto base stations involving the use of FIDs. A Femto base station is being installed and put into operation for the first time. This may be, for example, in the home of a subscriber or the premises of an enterprise. The Femto base station is turned on for the first time 202 and has its initial boot 204. After initial start up, the Femto base station boots and performs an autonomous device integrity self-validation to ensure that it has not been tampered with. Once no tampering has been confirmed, the Femto base station starts a user equipment (UE), or listening, mode in which it obtains location information, for example by collecting an FID or FIDs, then carries out a discovery procedure 206. The OAM discovery procedure is carried out between the Femto base station and a management server (MS)/OAM system. During the discovery procedure 206 the Femto base station may obtain information such as PLMN information and addresses for gateways and other entities. During this procedure 206, the Femto base station can report location information such as FID(s). The MS/OAM system can specify the location information to be provided.

Following the discovery procedure, the Femto base station carries out a registration procedure with the OAM system 208 in which it is checked and partially or fully configured for operation. The OAM registration procedure is carried out between the Femto base station and the MS/OAM system. During this procedure 208, the Femto base station reports location information specified by the MS/OAM system during the discovery procedure 206. The MS/OAM system uses received location information to carry out LV. The LV can be very rough, that is checking that the country configured in the Femto base station is correct, or can be more specific, that is to confirm that the Femto base station is in the correct location, for example close to a particular, specified, address.

Assuming that the registration procedure 208 is successful, the Femto base station carries out a registration procedure with the network 210. For 3G networks, the network registration procedure is carried out between the Femto base station and an HNB gateway (HNB-GW). For an LTE network, the network registration procedure is carried out between the Femto base station and a network node such as a mobility management entity (MME). During this procedure 210 LV is defined as an option for 3G, that is during registration of 3G Femto base stations to the HNB-GW a protocol referred to as the iuh protocol provides location information as configured by the OAM system. In this case, the HNB-GW performs LV. Otherwise, provided location information may not be used and so may be ignored. In case of LTE Femto base stations, they use a protocol referred to as the S1 protocol during registration to the MME, with the HeNB-GW being used only as a proxy which forwards registration requests to an available MME. The S1 protocol is not able to transport location information, that is LV cannot be performed by the MME.

The Femto base station may be provided with air interface settings during OAM discovery and/or OAM registration, if any are needed beyond any air interface settings which may have been stored internally in the Femto base station as factory default settings. The foregoing is carried out only once unless the procedure has been finalised successfully or the Femto base station is reset to factory defaults.

As will be understood from the foregoing, LV, whether to determine location in terms of coarse or fine granularity, is carried out during the discovery and registration procedures.

In addition to LV being carried out on discovery and registration of a Femto base station during its initial set up, according to the invention it has been recognised that it is also desirable for LV to be carried out during an operational phase, that is following a successful discovery and registration, in order to detect subsequent location changes of the Femto base station. Due to the fact that a Femto base station is only allowed to activate its transmitter when it has an active connection to a core network, according to the invention LV can be performed during the operational phase of a Femto base station by OAM system and by the core network

In LTE, Femto base stations communicate with the core network by using the S1 protocol. The S1 protocol defined for HeNBs is not able to transport LV information and LV is performed in the OAM system. Alternatively, location information may be provided to an HeNB if an S1 protocol extension is implemented. In 3G systems, Femto base stations communicate with the core network via the HNB-GW since the iuh interface is terminated at the gateway. The iuh interface transports LV information and the gateway may support the LV check as an option and LV for 3G systems may be performed by the OAM system, or by the HNB-GW, or by both systems.

LV can be carried out during operation of a Femto base station in various ways, for example in the Femto base station, between the Femto base station and the MS/OAM system, or between the Femto base station and a suitable network element such as an H(e)NB-GW or an MME. In respect of an HeNB-GW, MME, or other network element, this functionality, if LV is to be applied, may be added at the respective protocol level (for example the S1 protocol for LTE) and at an appropriate network element. As will be understood from the foregoing, the MS/OAM system can carry out LV to determine location, whether in terms of coarse or fine granularity, during the operation of the Femto base station.

To avoid an excess control overhead, the state model shown in FIG. 2 may contain additional features. All FIDs which are received during the discovery and registration procedure 206 are stored and locked (that is, protected against overwriting and manipulation) in the Femto based station. In this context, lock means once FIDs have been received, they are maintained and used for local detection of new FIDs. The local detection may be at a Femto base station or elsewhere. When a new FID does not match locked FIDs, a security alarm is triggered which may result in a Femto base station being provided with an instruction to cease operation. The locking mechanism is used once a Femto base station has undergone successful OAM discovery and OAM registration procedures. The detection of new FIDs may result in them being reported to the OAM system for further processing.

As described in the foregoing, the FIDs are used during the discovery and registration procedure 206 as LV information. The OAM system performs location verification by checking whether the received FIDs belong to an expected location or not. If location verification is successful, defined discovery and registration process steps are performed. If location verification is not successful, defined failure measures are executed. This may include, for example, sending an alarm to a higher management system, switching off the air interface of the Femto base station, and/or resetting it.

After a successful discovery and registration procedure, during normal operation the Femto base station checks whether FIDs received periodically are already locked, that is stored in the Femto base station, or are new, that is, not stored. In other embodiments of the invention, the FIDs may be checked in the OAM system, in a SON server, or in another network entity such as a gateway, for example an HNB-GW or an HeNB-GW, or an MME. In case a received FID is already locked, it is determined that the location has not been changed.

In the specific example of FID checking taking place in a Femto base station, if an FID detected as being “new”, the Femto base station may initiate a TR-069 session and informs the OAM system immediately about the new FID. The OAM system checks if the new FID belongs to the location expected for the Femto base station. If it is determined that the new FID belongs to the expected location, the OAM system instructs the Femto base station to lock the new FID and this new FID is stored in the Femto base station. If it is determined that the new FID does not belong to the expected location, the OAM system initiates failure measures, for example it resets the Femto base station to factory default settings, switches off its air interface, and/or sends a reboot with factory defaults command.

A procedure based on checking FIDs can also be applied to a case of re-location of a Femto base station. In this case, the user of a Femto base station may wish to change the location of the Femto base station and therefore notifies the change to the relevant network operator. As a result, relevant information may be registered and provisioned to the network allowing a network operator to change any locked location. Following this, the OAM system may check if any new FIDs reported by the Femto base station match the registered (new) location and if a move has already been registered with a relevant re-location functionality, operation of the Femto base station in its new location may be permitted. Femto base station re-location is a network procedure. Instead of using an OAM process it is possible to implement a LV mechanism. In this case, the FIDs need to be transported as additional information in Femto base station re-location messages. If an FID check in the context of re-location is successful the old FIDs are deleted and the new FIDs are locked at the Femto base station, and if it is unsuccessful, defined failure measures are initiated.

Different implementations of the invention may be provided according to the location in which LV occurs and/or the entity which performs this function. Examples are presented in the following use cases. In the use cases, the term LV refers to the matching between received FID(s) and expected FID(s). It should be noted that the LV referred to in the following use cases refers both to LV being carried out during discovery and registration and to LV being carried out during the operation of a Femto base station.

In a first use case, LV is performed in the network within the domain of the MNO. This may be in the OAM system and/or in a SON server, or in other network entity such as a gateway or an MME. In this case, the prerequisites are that a macro base station eNB is configured with an FID. A Femto base station receives the FID while it is in listening mode, and then sends the received FID to the network. The network performs LV by comparing the received FID to an expected FID and initiates actions related to the result, such as activating or blocking the Femto base station.

The first use case is shown in FIG. 1. In this case, in step a1, a Femto base station, having received an FID specific to a macro base station sends the received FID via the DSL connection to the CSL which then forwards the FID, or more correctly a message containing the FID, to the MNO. This message may also contain an identifier of the Femto base station. Once the MNO receives the message, it is provided to the OAM system or to a SON server in the domain of the MNO. In step b1, the OAM system or SON server compares the received FID to a database containing expected FIDs for the Femto base station in order to confirm that it has received a valid FID. Assuming that the FID is confirmed as being valid, in step c1, the OAM system or SON server sends an activation message, meaning that the Femto base station is allowed to activate its transmitter block, to the Femto base station. This is described further in the following.

In a second use case, LV is performed directly in a Femto access point. In this use case, the prerequisites are that a macro base station eNB is configured with an FID and a

Femto base station is configured with an expected FID. The pre-configurations of the macro base station and the Femto base station may be carried out by the OAM system or by a SON server. The Femto base station receives the FID while it is in listening mode, compares the received FID to the expected FID and initiates actions related to the result, such as permitting continuous use, sending an information item (for example an alarm) to the network, informing the network about a local LV result, switching off the air interface, or initiating a reboot, as appropriate.

In a third use case, LV is performed indirectly in a Femto access point. In this use case, the prerequisites are that a macro base station eNB is configured with an FID and a Femto base station is configured with an expected FID. It should be noted that the FID is used as an encryption and/or decryption key by the Femto base station. The preconfiguration of the macro base station and the Femto base station may be carried out by the OAM system or by a SON server. In addition, a network node (for example an MME assuming that encryption is applied to c-plane traffic or an S-GW assuming that encryption is applied to u-plane traffic in the case of an LTE network, and an HNB-GW in the case of a 3G network) which is configured to receive OAM, user, or signalling traffic from the Femto base station is configured with a counterpart to the expected FID configured into the Femto base station. It should be noted that it may be configured with counterparts to several expected FIDs of macro base stations in the vicinity of the Femto base station. The expected FID counterpart is to be used as a decryption and/or encryption key by the network node which receives user traffic from the Femto base station. The Femto base station receives an FID while it is in listening mode. However, unlike the preceding use cases, neither the Femto base station nor the network node performs a comparison of a received FID with an expected FID. Instead, the Femto base station generates a message specific code, such as a MAC (message authentication code), based on the data/payload of a packet. The code may be generated for all packet data types, for example user and control data packets, or for a subset of data packet types. The code may only be applied to some packets of a certain data type, for example to every tenth or every hundredth packet. The Femto base station encrypts the codes with a received FID, which may be one of several received FIDs, adds the encrypted codes to data packets and sends the data packets with the encrypted codes to the network. The network node which receives data packets uses the expected FID counterpart, or a number of several expected FID counterparts in turn, to decrypt the codes and checks whether a particular code is valid for a data packet. If the code cannot be decrypted correctly, this indicates that the used FID is not an expected FID, which itself indicates that the Femto base station is operating in an incorrect location. The network node may generate an alarm informing the OAM about the mismatch. A corresponding “opposing” procedure can be used in which the network node encrypts codes for data packets using the expected FID counterpart and the Femto base station decrypts the codes with the received FID. In the case of a mismatch the Femto base station may perform defined actions related to the result, such as sending an alarm to the network, informing the network about a local LV result, switching off the air interface, initiating a reboot, as appropriate.

The encryption key may be an FID or may be based on an FID. In another implementation the FID may be used in combination with a network identifier, such as a PLMN-ID.

A specific example of the third use case is shown in FIG. 1. In this case, a Femto base station, having received an FID specific to a macro base station uses the received FID in step a2 to cipher user or control data and then sends corresponding messages via the DSL connection to the CSL which then forwards the ciphered messages to the MNO. The messages may also contain an identifier of the Femto base station. Once the MNO receives the messages, they are provided to the OAM system or a SON server in the domain of the MNO, or to another network node. In step b2, the OAM system or SON server deciphers the messages in order to confirm that the messages were ciphered according to a valid FID. Assuming that the FID is confirmed as being valid, in step c1, the OAM system or SON server may send an activation message to the Femto base station, or may allow the Femto base station to continue its operation in the network, depending on the circumstances.

Therefore, it will be understood that the third use case performs location verification via another functionality not involving a direct comparison of FIDs. However, the result is as good as a direct location verification function.

As can be seen in the use cases above, LV may take place according to a number of methods. Accordingly, in one implementation of the invention, a global function block which acts as an LV server function is implemented. This server function can be implemented in the Femto base station, the H(e)NB-GW, the OAM system, the SON server, or in any other appropriate network node. The server functionality may even be divided and distributed over several different network nodes and/or OAM systems. In the case of using a server function, this is provided with information in the form of the prerequisites. This information may be provided via an LV client function. The LV client function may be independent of any network node or OAM system.

In this description, in functional terms the OAM system may be considered to be equivalent to the SON server. For example a SON server may a sub-functionality of the OAM system.

As can be seen from the foregoing, if a received FID is checked at a Femto base station, this means that the Femto base station has been previously configured with one or more “expected” FIDs. A Femto base station may be configured, by configuration management, with “expected” FIDs as follows:

(1) as a factory default configuration;

(2) during an OAM discovery procedure;

(3) during an OAM registration procedure; and/or

(4) during OAM operation (this option being primarily used to configure FID changes).

The LV server function referred to in the foregoing, in respect of options (2), (3), and (4), may be installed either at a Femto base station or at any suitable network node (whether as a centralised or as a distributed function). In respect of option (1) the LV server function is installed at a Femto base station and an MNO may apply a policy that accepts a general FID which is received from one or many macro base stations. As an example, an MNO uses FIDs which include country and/or regional information. The MNO is not necessarily interested in the exact location of a Femto base station during its first power-on but may wish to ensure that the Femto base station is a model which is preconfigured for a specific country and/or region (specified by its factory default settings). The Femto base station is able to check via the LV server function received FIDs (sent by macro base stations) and to determine that the part of the FIDs which represents a country and/or a region matches the corresponding part of a FID configured in the factory default settings. In other words the factory default settings may include the policy rules as well as expected country and/or region FIDs.

Turning now to a finer checking of location, when a subscriber wants to acquire and set up a Femto base station, the MNO may request information about its intended location of operation. In many cases this will be at a subscriber's home. The MNO, on receiving this information, checks which macro base stations are near to the subscriber's home location and may prepare the corresponding configurations to the macro base stations, the Femto base station, and/or the LV server function according to the foregoing use cases. Therefore, for these use cases, when ordering/receiving/setting up a Femto base station, its user may make a statement of the expected location where it will be used, with this expected location being used to pre-configure the LV server function (located in the Femto base station or otherwise) with expected FID(s) to be used in LV. Received FID(s) are then used to confirm the expected location/expected FID(s) with the location being verified at the LV server function based on a pre-configured policy rule.

Therefore, it will be understood from the foregoing that there can be region/country location information made available in the form of expected and broadcast FIDs, or alternatively there can be highly localised location information made available in the form of expected and broadcast FIDs. In this way, LV can be performed as a coarse location check or as a fine location check. In one embodiment of the invention, both types of information may be made available in the expected and broadcast FIDs and both coarse and fine LV may be carried out either at the same times or at different times, for example during different operations. In one specific example, coarse LV may be carried out during registration of a Femto base station and fine LV may be carried out during its operation.

Policy rules will now be described and two examples are given in the following. FIG. 3 shows an arrangement of a Femto base station (FAP) and macro base stations (Macro1, Macro2, and Macro3). The Femto base station can occupy a number of locations, presented here as location 1 to location 100, and in this particular case is located at location 50. It should be noted that this is simply a schematic representation for the purposes of illustrating principles of the invention. It should also be noted that the LV referred to in these examples refers both to LV carried out during discovery and registration and to LV carried out during operation of a Femto base station.

In a first example, a fine level granularity of location is determinable depending on the number of possible FIDs (the FID space):

Macro1 is configured to send FID=0001

Macro2 is configured to send FID=0002

Macro3 is configured to send FID=0003

The LV server function is configured that the expected FID for a Femto base station at location 50 is ExpFID=0001 and 0002 and 0003.

Result: Location of the Femto base station is accepted when a pre-defined policy is fulfilled.

The Femto base station receives three FIDs, 0001, 0002, and 0003, and reports them to the LV server function. Each FID is received by the Femto base station independently and will be reported in single separate messages or in a combined message to the LV server function.

The policies in this first example may take a number of forms:

1) Reported FIDs must be ExpFID 0001, 0002, or 0003.

2) Reported FIDs must match a combination of two ExpFIDs, that is the ExpFIDs are 0001 and 0002, 0001 and 0003, or 0002 and 0003.

3) Reported FIDs must match to all three ExpFIDs 0001, 0002, and 0003.

LV is successful when:

a) any of 1), 2), and 3) is fulfilled; b) condition a) is met but no other FIDs are reported; c) etc.

In a second example, a coarse level granularity of location is determinable based on fewer possible FIDs, or even a single FID:

Macro1 is configured to send FID=0001

Macro2 is configured to send FID=0001

Macro3 is configured to send FID=0001

The LV server function is configured that the expected FID for a Femto base station located at location 50 is ExpFID=0001.

Result: Location of the Femto base station is accepted when a pre-defined policy is fulfilled.

The Femto base station receives from Macro1 and/or Macro2 and/or Macro3 the FIDs 0001 and reports it or them to the LV server function. Each FID is received by the Femto base station independently and will be reported in single separate messages or in a combined message to the LV server function.

The policies in this second example may take a number of forms:

1) Reported FID(s) must be ExpFID 0001.

2) Reported FIDs must be received by Macro1, Macro2, or Macro3 or a combination of two Macros or from all three Macros.

LV is successful when:

a) rule 1) is fulfilled; b) rule 1) and 2) is fulfilled; c) either condition a) or condition b) is met but no other FIDs are reported; d) etc.

If there is no match between an expected FID and a received FID, the Femto base station is not allowed to use the transmit capability of the air interface. The Femto base station may be able to establish a tunnel to allow the OAM system to send configuration or software updates but no mobile terminal can connect because the Femto base station is not broadcasting. Additional measures/configurations may be applied which will solve the problem of there not being a verified location in a case in which there is no match between an expected FID and a received FID according to those determined by the MNO.

Referring back to FIG. 1, in order to receive/detect the FIDs, the Femto base station 102 is provided with basic user equipment (UE) functionality. If more complex functions are needed, this may be provided at a relatively low cost compared to a UE such as a mobile phone because there is no need for a battery, a display, and other costly functions. The necessary UE functionality may be provided to the Femto base station 102 simply by including in it a suitable computer chip/processor. However, in another embodiment of the invention, a user may provide UE functionality to a Femto base station. This may be carried out by a mobile terminal, such as a mobile phone, of the user being capable of detecting the FID and transferring it to the Femto base station over an air interface radio link between the mobile phone and the Femto base station, for example a 3G or an LTE air interface useable for communicating user data between the mobile terminal and the core network. In this way, the mobile terminal may act like a relay.

Until a correct FID is provided by the mobile phone, the Femto base station may be active (for example it may be in a receive mode), but may not be able to transmit any user data.

There may be a lifetime, or a period of validity, associated with the FID. In this case, a time stamp associated with the FID may be compared with a time provided by a clock maintained in the mobile terminal, or in a Femto base station receiving the FID (and associated time stamp) from the mobile terminal, to confirm, or reject, validity. In other words, in the case of a mobile terminal received FID, validity may be checked in a number of entities such as in the mobile terminal or in a Femto base station. In order for an entity in the network to declare an FID as valid it is necessary for the mobile terminal to retransmit it to the Femto base station within a certain time window after reception.

In order to provide this embodiment of the invention, the mobile terminal is modified to be able to detect FIDs and send them to Femto base stations. This functionality may be embedded into mobile terminals as a standardised capability or it may be implemented as a specific mobile terminal application, where received data values are simply forwarded by the mobile terminal. It should be noted that in this embodiment of the invention, since a mobile phone may be the source of a FID, then FIDs may be included in BCH messages.

Once the mobile terminal has provided the FID(s) to a Femto base station, the Femto base station may use the FID(s) in a way corresponding to direct receipt of the FID(s). Once the Femto base station has had its location verified and is operational, the mobile terminal may then be handed over by a macro base station, perhaps by a macro base station which provided the FID(s), to the Femto base station.

It will be seen that it is useful for the Femto base station to obtain location information based on the FID or FIDs. Therefore, the following is concerned with how this information may be obtained, and also how it may be used.

The FIDs, or more particularly FID messages containing the FIDs, are broadcast by the macro base stations 108, 110 as is explained in the foregoing. This may be periodically, with a fixed period being in the range of 10 to 60 minutes. In order to improve the chances of detection, the messages, or just the FIDs, may be encoded and/or modulated in a form having a strong coding gain. For example, the coding or modulation may be strong with respect to standard BCH messages containing cell ID information, for example the relative coding gain between the FID messages and the standard BCH messages can be as large as 20 dB. This can improve the chances that such messages are received by the Femto base station inside a building, for example even in the cellar of a building. With a sufficiently high coding gain, reception can almost be guaranteed by any Femto base station in its vicinity, even if it is experiencing strong damping, for example because of coated windows. Since these messages are transmitted very infrequently, and typical message lengths are short, the overall overhead for these messages can be kept low despite the large coding gain. It should be noted that in an implementation of the invention in which the FIDs are not transmitted in BCH messages, but as separate broadcasts, there is no need to modify already standardised air interface messaging.

Strong coding may be provided by simple repetition coding of the FID messages. The length of an FID may be in the order of 6 to several tens of bits. A short FID may be sufficient for coarse location verification, for example to identify a particular network, a region, or a country. A long FID may be sufficient for a fine level of location verification since tens of bits could provide a FID space of a million possibilities or more. Further information might be sent to the Femto base station, for example power control information or preferred frequency sub-bands etc. In this case, additional control bits may be added. A coding gain of 20 dB may be provided by simple repetition coding by having a repetition factor of 100. Assuming a basic coding rate of one third having already been applied this would result in 3000 bits for a 10 bit long FID message, that is an overall factor of 300. This factor may be applied to an FID itself or to an FID and also to further information which is sent. Alternatively, a relatively high factor may be applied to an FID and a lower factor applied to any further information. The repetition factor and/or the overall factor may be reduced by more efficient coding schemes and/or by adding macro diversity as is discussed in the following. In the case of a macro base station transmitting one FID every 10 minutes, the overhead of additional bits to be transmitted, whether this is just the FID or the FID and the further information, is small and may be in the order of 1 part per million of all of the bits being transmitted.

The nature of the FID may be subject to a number of implementation choices as will now be described. In a first implementation, each macro base station has its own unique FID (at least in a local neighbourhood sense because FIDs may be re-used across an entire network). However, in an alternative implementation, several adjacent macro base stations are configured to transmit the same FID simultaneously to allow a gain provided by macro base station diversity. If this provides a sufficient reception gain for Femto base stations, applying a coding gain may not be necessary, or the amount of coding gain required may be reduced when compared to relying solely on coding gain without there being any macro base station diversity gain. By setting up different time slots for different FID broadcasts, each macro base station can be part of several single frequency networks (SFN) for the FID transmission. In this way, several macro base stations form a single frequency network which sends the same FID. Macro diversity or COMP functions may enable an MNO to receive FIDs and be able to identify the area where the FID is being broadcast thus enabling the determination of a finer, that is a more precise, localisation of Femto base stations based on the relative strengths of several FIDs from different SFNs.

In the case of macro diversity, in a mobile communications network synchronisation provides the basis for communication. Accordingly, a number of options may be provided:

a) an unsynchronised inhomogeneous detection scheme is used, requiring a completely new communication set-up; or

b) a synchronisation signal is coupled with the FID so that the FID increases synchronisation probability, that is the FID is basically a synchronisation signal either in or not in combination with an LTE synchronisation signal.

Further implementation choices may be applied in combination with any of the foregoing features of the invention:

1) Improved security can be achieved if the FID is changed from time to time, for example for every transmission, or more infrequently. By implementing dynamic FIDs, for example randomly generated FIDs, it is possible to change FIDs in an area automatically. For example, an FID received in an area may only be valid in a predefined time interval. In other words, any FID may be only valid for a configurable time period. Such a period may be 10 minutes. This may equate to one broadcast.

2) At system start-up it can be helpful for the Femto base station to know the time when an FID will next be broadcast. Therefore, in an enhanced implementation, as part of the configuration set up of a Femto base station, it is informed over the DSL backbone by a suitable message about a measurement time window when the next FID will be transmitted by the macro base station.

The features 1) and 2) may apply both to direct and indirect LV embodiments of the invention.

Therefore, it can be seen from the foregoing that in order to implement the invention, a number of features may be included in a Femto base station:

a) The data model of a Femto base station defines the parameters to be used and how they are to be manipulated, for example a GET parameter and a READ parameter, which allow the Femto base station to store and lock FIDs.

b) A processor capability, such as a processor block, to process received management commands for the FIDs via TR-069 (including the capability to write authorisation in the Femto data model).

c) A compare capability, such as a comparator block, to check in operation whether a received FID is already locked or is new.

d) An enforced inform method according to TR-069 to report new detected FIDs.

It can also be seen that a number of features may be included in a Femto management system such as an H(e)NB Management System:

a) Access to an information store containing information of which FIDs are allowed for an expected Femto base station location, for example providing by provisioning via a Type 2 interface or by access to a relevant database.

b) A capability to manage (write) FIDs via TR-069 at the Femto base station.

The invention may provide an additional advantage in an implementation in which there is a large number of Femto base stations. Although periodic location verification using direct LV might lead to a significant control overhead burden, in some cases some, but not all, FIDs may be checked. This could be done by identifying if an excessive amount of LV is required and choosing not to carry it all out or carrying out only a defined or calculated proportion of the LV. According to indirect LV by using ciphering/deciphering, it is not necessary for a large number of Femto base stations to provide FID updates in order to maintain periodic location verification. As a result, this reduces the central load on the system, for example on any entity carrying out LV.

It will be seen that the invention provides a capability to determine whether a Femto base station has been moved from one location to another.

In a variant of the invention, a Femto base station is able to receive FIDs from nearby Femto base stations. This variant can be adapted to networks comprising Femto base stations solely or where they are in the majority. In such a variant, reference Femto base stations may be defined which are configured to broadcast FIDs.

In a further variant, the invention is applied to home base stations in general and does not specifically apply only to Femto base stations.

It should be noted that although in the preceding embodiments LV is described having been based on FIDs, in a variation of the invention, location is indicated by another item of location information such as that indicated by an IP address or by GPS coordinates.

While preferred embodiments of the invention have been shown and described, it will be understood that such embodiments are described by way of example only. Numerous variations, changes and substitutions will occur to those skilled in the art without departing from the scope of the present invention. Accordingly, it is intended that the following claims cover all such variations or equivalents as fall within the spirit and the scope of the invention.

1. A method of verifying the location of a home base station comprising the steps of:
receiving a broadcast location identifier; and
checking whether the location identifier is valid for the location of the home base station in order to verify its location.

2. A method according to claim 1 in which the location identifier is broadcast by a macro base station.

3. A method according to claim 1 in which the location identifier is unique to a particular set of base stations comprising at least one base station.

4. A method according to claim 1 in which the location identifier is unique to a region.

5. A method according to claim 1 which is performed as a coarse location check and as a fine location check.

6. A method according to claim 1 in which location verification is performed during a discovery and registration procedure of the home base station.

7. A method according to claim 1 in which location verification is performed during operation of the home base station.

8. A method according to claim 1 in which the location identifier is locked to a network element.

9. A method according to claim 8 in which if it is determined that a new location identifier, received as a result of a re-location of the home base station, belongs to an expected location, the network element is instructed to lock the new location identifier.

10. A method according to claim 1 which is performed in a network.

11. A method according to claim 1 which is performed in the home base station.

12. A method according to claim 1 which is performed indirectly in a home base station operating together with a network based entity.

13. A method according to claim 1 in which the location identifier is used as an encryption and/or decryption key by the home base station and a network element configured to communicate with the home base station.

14. A method according to claim 13 in which the location identifier is used to encrypt a message or a part thereof.

15. A method according to claim 1 in which a mobile terminal is used to receive the location identifier and provide it to the home base station.

16. A method according to claim 1 in which the location identifier, or a message containing it, is encoded in a form having a coding gain stronger than broadcast channel messages by a defined amount.

17. A method according to claim 1 in which several macro base stations are configured to transmit the same location identifier simultaneously to allow a gain provided by macro base station diversity.

18. A network node capable of verifying the location of a home base station, the network node comprising a receiving block capable of receiving a broadcast location identifier; and
a checking block to determine whether the location identifier is valid for the location of the home base station in order to verify its location.

19. A network comprising:
a plurality of base stations capable of broadcasting a location identifier; and
a network node capable of verifying the location of a home base station, the network node comprising a receiving block capable of receiving a broadcast location identifier and a checking block to determine whether the location identifier is valid for the location of the home base station in order to verify its location.

20. A computer program product comprising software code that when executed on a computing system performs a method of verifying the location of a home base station comprising the steps of:
receiving a broadcast location identifier; and
checking whether the location identifier is valid for the location of the home base station in order to verify its location.
